(19) United States
(12) Patent Application Publication
(10) Pub. No.: US 2005/0164531 A1
(43) Pub. Date: Jul. 28, 2005

(54) Connector coupled to board module

(76) Inventor: Henry Wong, Tempe, AZ (US)

Correspondence Address: MOTOROLA, INC., LAW DEPARTMENT, 1303 E. ALGONQUIN ROAD, SCHAUMBURG, IL, 60196, US

(21) Appl. No.: 10/764,898

(22) Filed: Jan. 26, 2004

(51) Int. Cl. H01R 12/00

(52) U.S. Cl. 439/79

(57) ABSTRACT

A board module (401) can include a board module surface (420) and a connector (403) coupled to the board module surface, wherein the connector is coupled to provide at least one signal (112, 114) to the board module. The connector can include a connector lead surface (419) substantially perpendicular to the board module surface (420); a first row of leads (430) substantially parallel to and a first distance (451) from the board module surface extending substantially perpendicular from the connector lead surface (419) and shaped to connect substantially perpendicular to the board module surface at a second distance (452) from the connector lead surface; and a second row of leads (440) substantially parallel to and a third distance (453) from the board module surface extending substantially perpendicular from the connector lead surface (419) and shaped to connect substantially perpendicular to the board module surface (420) at a fourth distance (454) from the connector lead surface. The first distance is greater than the third distance, the second distance is less than the fourth distance, and each of the second row leads are offset from each of the first row of leads.

### BACKGROUND OF THE INVENTION

Prior art chassis mounted computer systems have been increasing in complexity. Due to this increasing complexity, board real estate is becoming crowded, with connectors being required to connect ever more devices to the backplane of the chassis. In addition, mezzanine cards mounted to computer boards can interfere with connector leads for the computer boards, further exacerbating the problem of limited board real estate. Current connectors are disadvantageous in that as leads are added to accommodate more devices and functions, interference with mezzanine cards and other devices on the computer board are only increased.

Accordingly, there is a significant need for an apparatus that overcomes the deficiencies of the prior art outlined above.

### BRIEF DESCRIPTION OF THE DRAWINGS

Referring to the drawing:

FIG. 1 depicts a block diagram of a multi-service platform system according to one embodiment of the invention;

FIG. 2 depicts a board module according to an embodiment of the invention;

FIG. 3 depicts a board module and backplane according to an embodiment of the invention; and

FIG. 4 depicts a connector according an embodiment of the invention.

It will be appreciated that for simplicity and clarity of illustration, elements shown in the drawing have not necessarily been drawn to scale. For example, the dimensions of some of the elements are exaggerated relative to each other. Further, where considered appropriate, reference numerals have been repeated among the Figures to indicate corresponding elements.

### DESCRIPTION OF THE PREFERRED EMBODIMENTS

In the following detailed description of exemplary embodiments of the invention, reference is made to the accompanying drawings, which illustrate specific exemplary embodiments in which the invention may be practiced. These embodiments are described in sufficient detail to enable those skilled in the art to practice the invention, but other embodiments may be utilized and logical, mechanical, electrical and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known circuits, structures and techniques have not been shown in detail in order not to obscure the invention.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact. However, “coupled” may mean that two or more elements are not in direct contact with each other, but yet still co-operate or interact with each other.

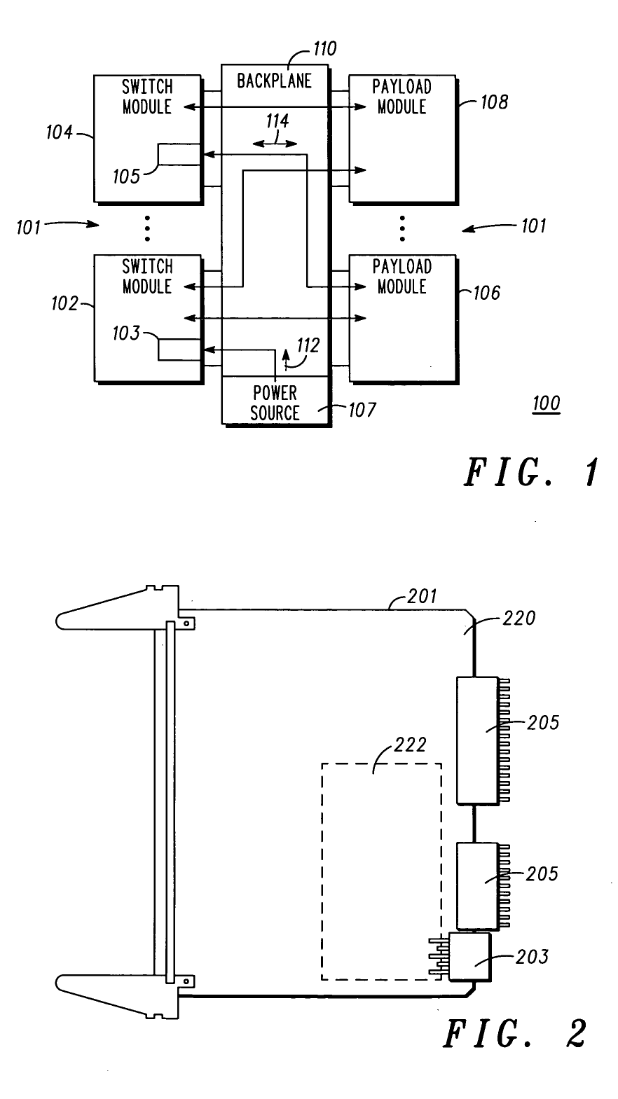

FIG. 1 depicts a block diagram of a multi-service platform system 100 according to one embodiment of the invention. Multi-service platform system 100 can include a multi-service platform system chassis, with software and any number of slots for inserting board modules 101, for example, switch modules 102, 104 and payload modules 106, 108. Backplane 110 can be used for connecting board modules 101 placed in slots. As an example of an embodiment, a multi-service platform system 100 can include chassis having model MVME5100 manufactured by Motorola Computer Group, 2900 South Diablo Way, Tempe, Ariz. 85282. The invention is not limited to this model or manufacturer and any multi-service platform system is included within the scope of the invention.

As shown in FIG. 1, multi-service platform system 100 can comprise a switch module 102, 104 coupled to any number of payload modules 106, 108 via backplane 110. Backplane 110 can accommodate any combination of a packet switched backplane including a distributed switched fabric or a multi-drop bus type backplane. Payload module 106, 108 can add functionality to multi-service platform system 100 through the addition of processors, memory, storage devices, I/O elements, and the like. In other words, payload module 106, 108 can include any combination of processors, memory, storage devices, I/O elements, and the like, to give multi-service platform 100 the functionality desired by a user. In an embodiment, there are 18 payload slots for 18 payload modules in multi-service platform system 100. However, any number of payload slots and payload nodes are included in the scope of the invention.

In an embodiment, multi-service platform system 100 can use switch module 102, 104 as a central switching hub with any number of payload modules 106, 108 coupled to switch module 102, 104. Multi-service platform system 100 can be based on a point-to-point, switched input/output (I/O) fabric. Multi-service platform system 100 can include both node-to-node (for example computer systems that support I/O node add-in slots) and chassis-to-chassis environments (for example interconnecting computers, external storage systems, external Local Area Network (LAN) and Wide Area Network (WAN) access devices in a data-center environment). Multi-service platform system 100 can be implemented by using one or more of a plurality of switched fabric network standards, for example and without limitation, InfiniBand™, Serial RapidIO™, Ethernet™, and the like. Multi-service platform system 100 is not limited to the use of these switched fabric network standards and the use of any switched fabric network standard is within the scope of the invention. In another embodiment, multiple switch modules 102, 104 can be used in multi-service platform system 100.

In one embodiment, backplane 110 can be an embedded packet switched backplane as is known in the art. In another embodiment, backplane 110 can be an overlay packet switched backplane that is overlaid on top of a backplane that does not have packet switched capability. In any embodiment of the invention, switch module 102, 104 is coupled to payload modules 106, 108 via backplane 110. In an embodiment, backplane 110 comprises plurality of links capable of transmitting signal 114 from/to switch module 102, 104 and payload module 106, 108. As an example of an embodiment, each of plurality of links can comprise two 100-ohm differential signaling pairs.

In an embodiment, backplane 110 can use the CompactPCI Serial Mesh Backplane (CSMB) standard as set forth in PCI Industrial Computer Manufacturers Group (PCIMG®) specification 2.20, promulgated by PCIMG, 301 Edgewater Place, Suite 220, Wakefield, Mass. CSMB provides infrastructure for applications such as Ethernet, Serial RapidlO, Ethernet, other proprietary or consortium based transport protocols, and the like. In another embodiment multi-service platform system 100 can use an Advanced Telecom and Computing Architecture (AdvancedTCA™) standard as set forth by PCIMG.

In another embodiment, backplane 110 can use VERSAmodule Eurocard (VMEbus) switched serial standard backplane (VXS) as set forth in VITA 41 promulgated by VMEbus International Trade Association (VITA), P.O. Box 19658, Fountain Hills, Ariz., 85269 (where ANSI stands for American National Standards Institute). VXS includes a packet switched network on a backplane coincident with the VMEbus parallel-type bus, where VMEbus is a parallel multi-drop bus network that is known in the art.

Multi-service platform system 100 can include power source 107 to provide power, via backplane, to switch modules 102, 104 and payload modules 106, 108. As an example, power source can provide power signal 112 to switch module 102. Any number of power signals 112 can be provided to modules via backplane 110 having any number of voltages and be within the scope of the invention. Backplane 110 can also facilitate transmission of signal 114 to/from switch modules 102, 104 and payload modules 106, 108. Signal 114 can include data, such as packet data, bus data, and the like.

Board modules 101 can each have any number of connectors 103, 105 to couple board module 101 to backplane 110. As an example and not limiting of the invention, switch module 102 can have connector 103 coupled to receive power signal 112. As another example, switch module 104 can have connector 105 coupled to send/receive signal 114, which can be a data signal, and the like. Although not shown, payload modules 106, 108 can have any number of connectors coupled to receive signals, for example power signal 112, data signal 114, and the like.

FIG. 2 depicts a board module 201 according to an embodiment of the invention. As shown in FIG. 2, board module 201 can have a board module surface 220 to which are coupled any number of connectors 203, 205. In an example, and not limiting of the invention, board module 201 can be any one of a switch module, payload module, VMEbus switch module, VXS switch module, and the like. In the embodiment, where board module 201 is a switch module, board module surface 220 can be switch module surface. In the embodiment, where board module 201 is a payload module, board module surface 220 can be a payload module surface.

In an embodiment, connector 203 can be a power connector coupled to provide power to board module 201. In another embodiment, connectors 205 can be data connectors coupled to provide data to or from board module 201. The invention can be practiced using any of the power connector 203 and/or data connectors 205.

In an embodiment, board module can have mezzanine card envelope 222 where a mezzanine card can be coupled to board module 201 to provide additional functionality. Mezzanine card envelope 222 can include the area and/or volume that can be allotted to a mezzanine card attached to board module 201. Although any type of mezzanine card is within the scope of the invention, an exemplary mezzanine card can be a Common Mezzanine Card (CMC) having a CMC form factor. CMC form factor, including mechanical dimensions, electrical specifications, and the like, are known in the art and set forth in the Institute of Electrical and Electronics Engineers (IEEE) standard P1386. A particular example of an embodiment is a PCI mezzanine card (PMC) having a PMC form factor. PMC form factor, including mechanical dimensions, electrical specifications, and the like, are known in the art and also set forth in the Institute of Electrical and Electronics Engineers (IEEE) standard P1386.

In still another embodiment, mezzanine card envelope can accommodate a mini-PCI expansion card having a mini-PCI form factor. Mini-PCI cards and form factors are known in the art with mechanical, electrical and configuration standards set out in the Mini PCI Specification revision 1 or later and the PCI Local Bus Specification revision 2.3 or later as promulgated by the PCI Special Interest Group, 5300 N.E. Elam Young Parkway, Hillsboro, Oreg.

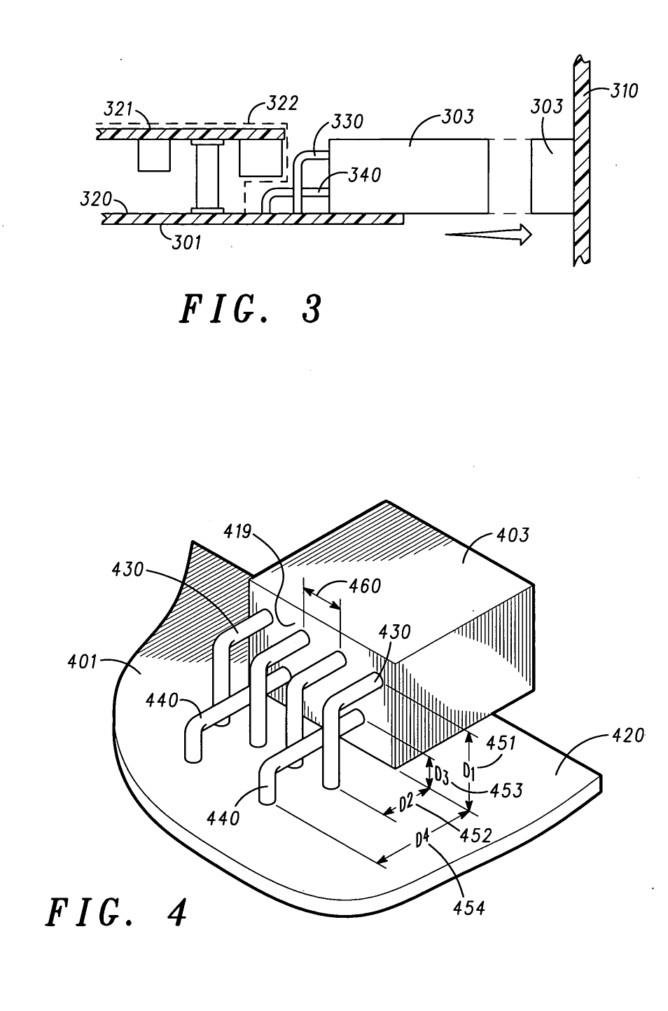

FIG. 3 depicts a board module 301 and backplane 310 according to an embodiment of the invention. As shown in FIG. 3, board module 301 can include connector 303, where a portion of connector is coupled to board module 301 and a portion of connector 303 is coupled to backplane. Each portion of connector 303 is designed to be electrically and mechanically coupled when board module 301 is inserted in a slot in chassis and coupled to backplane 310. Also shown in FIG. 3, is mezzanine card envelope 322 and mezzanine card 321 installed on board module 301 in mezzanine card envelope 322. In an embodiment of the invention, connector can include first row of leads 330 and second row of leads 340. Both first row of leads 330 and second row of leads 340 can communicatively couple board module 301 to backplane 310. For example, both first row of leads 330 and second row of leads 340 can be coupled to board module 301, for example, to metal traces on board module surface 320.

First row of leads 330 and second row of leads can be configured so as to not interfere or pass through mezzanine card envelope 322. For example, second row of leads 340 can extend farther than first row of leads 330 away from connector 303. Also, each of the second row leads 340 can be offset from each of the first row of leads 330 in a direction parallel to the board module surface 320.

FIG. 4 depicts a connector 403 according an embodiment of the invention. Connector can be coupled to board module 401 and coupled to provide at least one signal to board module 401. As shown in FIG. 4, connector 403 can include connector lead surface 419 substantially perpendicular to a board module surface 420. In an embodiment, first row of leads 430 can be substantially parallel to and a first distance (D1) 451 from the board module surface 420 extending substantially perpendicular from the connector lead surface 419 and shaped to connect substantially perpendicular to the board module surface 420 at a second distance (D2) 452 from the connector lead surface 419. First row of leads 430 can be shaped, for example and without limitation by an abrupt angle or a gentle angle having a radius of curvature.

In a embodiment, second row of leads 440 can be substantially parallel to and a third distance (D3) 453 from the board module surface 420 extending substantially perpendicular from the connector lead surface 419 and shaped to connect substantially perpendicular to the board module surface 420 at a fourth distance (D4) 454 from the connector lead surface 419. Second row of leads 440 can be shaped, for example and without limitation by an abrupt angle or a gentle angle having a radius of curvature. In an embodiment, first distance 451 is greater than third 453 distance, and second distance 452 is less than fourth distance 454. Also, in an embodiment, each of second row leads 440 are offset from each of first row of leads 430. In an embodiment, each of second row leads 440 are offset from each of first row of leads 430 in a direction 460 parallel to the board module surface 420.

In the embodiment depicted in FIG. 4, connector can be coupled to provide at least one signal to board module 401 without having any of its leads overlapping with a mezzanine card envelope. Although there are four first row leads 430 and two second row leads 440 depicted in FIG. 4, this is not limiting of the invention. Any number of leads can be present in first row leads 430 and second row leads 440. Moreover, although FIG. 4 depicts second row leads 440 offset between only a portion of first row leads 430, this is not limiting of the invention. Any number of first row leads 430 and second row leads 440 can be offset between each other and be within the scope of the invention. Although a power connector is depicted in FIG. 4, this is not limiting of the invention. Connector 403 can be a data connector on board module 401 and be within the scope of the invention.

While we have shown and described specific embodiments of the present invention, further modifications and improvements will occur to those skilled in the art. It is therefore, to be understood that appended claims are intended to cover all such modifications and changes as fall within the true spirit and scope of the invention.

1. A connector coupled to provide at least one signal to a board module, comprising:
a connector lead surface substantially perpendicular to a board module surface;
a first row of leads substantially parallel to and a first distance from the board module surface extending substantially perpendicular from the connector lead surface and shaped to connect substantially perpendicular to the board module surface at a second distance from the connector lead surface; and
a second row of leads substantially parallel to and a third distance from the board module surface extending substantially perpendicular from the connector lead surface and shaped to connect substantially perpendicular to the board module surface at a fourth distance from the connector lead surface, wherein the first distance is greater than the third distance, wherein the second distance is less than the fourth distance, and wherein each of the second row of leads are offset from each of the first row of leads.

2. The connector of claim 1, wherein the connector is coupled to communicatively couple the board module a backplane.

3. The connector of claim 1, wherein the connector is coupled to provide at least one power signal to a switch module.

4. The connector of claim 1, wherein the connector is coupled to provide at least one power signal to a VMEbus switch module.

5. The connector of claim 1, wherein the connector is coupled to provide at least one power signal to a VXS switch module.

6. The connector of claim 1, wherein each of the second row of leads are offset from each of the first row of leads in a direction parallel to the board module surface.

7. A board module, comprising:
a board module surface;
a connector coupled to the board module surface, wherein the connector is coupled to provide at least one signal to the board module wherein the connector comprises:
a connector lead surface substantially perpendicular to the board module surface;
a first row of leads substantially parallel to and a first distance from the board module surface extending substantially perpendicular from the connector lead surface and shaped to connect substantially perpendicular to the board module surface at a second distance from the connector lead surface; and
a second row of leads substantially parallel to and a third distance from the board module surface extending substantially perpendicular from the connector lead surface and shaped to connect substantially perpendicular to the board module surface at a fourth distance from the connector lead surface, wherein the first distance is greater than the third distance, wherein the second distance is less than the fourth distance, and wherein each of the second row of leads are offset from each of the first row of leads.

8. The board module of claim 7, wherein the connector is coupled to communicatively couple the board module a backplane.

9. The board module of claim 7, wherein the board module is a switch module, and wherein the connector is coupled to provide at least one power signal to the switch module.

10. The board module of claim 7, wherein the board module is a VME switch module, and wherein the connector is coupled to provide at least one power signal to the VMEbus switch module.

11. The board module of claim 7, wherein the board module is a VXS switch module, and wherein the connector is coupled to provide at least one power signal to a VXS switch module.

12. The board module of claim 7, wherein each of the second row of leads are offset from each of the first row of leads in a direction parallel to the board module surface.

13. A switch module, comprising:
a switch module surface;
a connector coupled to the switch module surface, wherein the connector is coupled to provide at least one signal to the switch module wherein the connector comprises:
a connector lead surface substantially perpendicular to the switch module surface;
a first row of leads substantially parallel to and a first distance from the switch module surface extending substantially perpendicular from the connector lead surface and shaped to connect substantially perpendicular to the switch module surface at a second distance from the connector lead surface; and
a second row of leads substantially parallel to and a third distance from the switch module surface extending substantially perpendicular from the connector lead surface and shaped to connect substantially perpendicular to the switch module surface at a fourth distance from the connector lead surface, wherein the first distance is greater than the third distance, wherein the second distance is less than the fourth distance, and wherein each of the second row of leads are offset from each of the first row of leads.

14. The switch module of claim 13, wherein the connector is coupled to communicatively couple the switch module a backplane.

15. The switch module of claim 13, wherein the connector is coupled to provide at least one power signal to the switch module.

16. The switch module of claim 13, wherein the switch module is a VME switch module, and wherein the connector is coupled to provide at least one power signal to the VMEbus switch module.

17. The switch module of claim 13, wherein the switch module is a VXS switch module, and wherein the connector is coupled to provide at least one power signal to a VXS switch module.

18. The switch module of claim 13, wherein each of the second row of leads are offset from each of the first row of leads in a direction parallel to the switch module surface.

19. A payload module, comprising:
a payload module surface;
a connector coupled to the payload module surface, wherein the connector is coupled to provide at least one signal to the payload module wherein the connector comprises:
a connector lead surface substantially perpendicular to the payload module surface;
a first row of leads substantially parallel to and a first distance from the payload module surface extending substantially perpendicular from the connector lead surface and shaped to connect substantially perpendicular to the payload module surface at a second distance from the connector lead surface; and
a second row of leads substantially parallel to and a third distance from the payload module surface extending substantially perpendicular from the connector lead surface and shaped to connect substantially perpendicular to the payload module surface at a fourth distance from the connector lead surface, wherein the first distance is greater than the third distance, wherein the second distance is less than the fourth distance, and wherein each of the second row of leads are offset from each of the first row of leads.

20. The payload module of claim 19, wherein each of the second row of leads are offset from each of the first row of leads in a direction parallel to the payload module surface.
